(19) United States
(12) Patent Application Publication
(10) Pub. No.: US 2007/0069429 A1
(43) Pub. Date: Mar. 29, 2007

(54) System and method for patterning a master disk for nanoimprinting patterned magnetic recording disks

(76) Inventors: Thomas R. Albrecht, San Jose, CA (US); Dennis R. McKean, Milpitas, CA (US); Gurinder Pal Singh, San Jose, CA (US); Henry Hung Yang, San Jose, CA (US)

Correspondence Address: THOMAS R. BERTHOLD, 18938 CONGRESS JUNCTION COURT, SARATOGA, CA, 95070, US

(21) Appl. No.: 11/241,284

(22) Filed: Sep. 29, 2005

(51) Int. Cl. B29C 35/08; B29C 67/00; G02B 1/12

(52) U.S. Cl. 264/482; 425/174.4; 425/810; 264/1.37; 264/400

(57) ABSTRACT

A system and method for patterning a master disk or “stamper” to be used for nanoimprinting magnetic recording disks uses an air-bearing slider that supports an aperture structure within the optical near-field of a resist layer on a rotating master disk substrate. Laser pulses directed to the input side of the aperture are output to the resist layer. The aperture structure includes a metal film reflective to the laser radiation with the aperture formed in it. The aperture has a size less than the wavelength of the incident laser radiation and is maintained by the air-bearing slider near the resist layer to within the radiation wavelength. The timing of the laser pulses is controlled to form a pattern of exposed regions in the resist layer, with this pattern ultimately resulting in the desired pattern of data islands and nondata islands in the magnetic recording disks when they are nanoimprinted by the master disk.

### BACKGROUND OF THE INVENTION

1. Field of the Invention

This invention relates generally to patterned-media magnetic recording disks, wherein each data bit is stored in a magnetically isolated data island on the disk, and more particularly to a system and method for patterning a master disk to be used for nanoimprinting the patterned-media disks.

2. Description of the Related Art

Magnetic recording hard disk drives with patterned magnetic recording media have been proposed to increase data density. In patterned media, the magnetic recording layer on the disk is patterned into small isolated data islands arranged in concentric data tracks. To produce the required magnetic isolation of the patterned data islands, the magnetic moment of spaces between the islands must be destroyed or substantially reduced to render these spaces essentially nonmagnetic. In one type of patterned media, as described for example in U.S. Pat. No. 6,440,520, the data islands are elevated regions or pillars that extend above the spaces and magnetic material covers both the islands and the spaces, but the spaces are far enough from the read/write head to not adversely affect reading or writing, so the spaces can be considered essentially nonmagnetic. Patterned-media disks also have nondata regions that are used for read/write head positioning and data synchronization. The nondata regions are nondata islands that extend radially across multiple data tracks and are separated by nonmagnetic spaces. Patterned-media disks may be longitudinal magnetic recording disks, wherein the magnetization directions are parallel to or in the plane of the recording layer, or perpendicular magnetic recording disks, wherein the magnetization directions are perpendicular to or out-of-the-plane of the recording layer.

One proposed method for fabricating patterned-media disks is by nanoimprinting with a master disk or “stamper” having a topographic surface pattern. In this method the magnetic recording disk substrate with a polymer film on its surface is pressed against the master disk. The polymer film receives the image of the master disk pattern and then becomes a mask for subsequent etching of the disk substrate. The magnetic layer and other layers needed for the magnetic recording disk are then deposited onto the etched disk substrate to form the patterned-media disk.

A major challenge is the patterning of the master disk for nanoimprinting. To achieve patterned-media disks with areal data densities greater than about 300 Gbit/in², the pattern period is typically below about 50 nm in the downtrack direction and the diameter of the data islands is below about 30 nm. These requirements are beyond the capability of conventional photolithography, and push electron-beam (e-beam) lithography to the very limits of its capability in terms of both minimum feature size and pattern writing time.

What is needed is a system and method for patterning the master disk with the required feature size that does not rely on conventional photolithography or e-beam lithography.

### SUMMARY OF THE INVENTION

A system and method for patterning a master disk to be used for nanoimprinting magnetic recording disks uses an air-bearing slider that supports an aperture structure within the optical near-field of a resist layer on a rotating master disk substrate. A liquid lubricant and/or a protective film, such as a carbon film, may be on the resist layer to improve the flyability of the slider supporting the aperture structure.

Laser pulses directed to the input side of the aperture are output to the resist layer. The aperture structure includes a metal film reflective to the laser radiation with the aperture formed in it. The aperture has a size less than the wavelength of the incident laser radiation and is maintained by the air-bearing slider near the resist layer to within the radiation wavelength. The reflective metal film surrounding the aperture may have periodic corrugations or ridges, which results in enhanced radiation transmission through the aperture when the incident laser radiation is resonant with surface plasmons at the corrugated film surface. The aperture may have a special shape, such as a “C”, “E”, “H”, or “bowtie” shape, which causes the surface plasmon resonant excitation to enhance the radiation transmission

The resist layer may be a thermal resist, such as a bismuth/indium (Bi/In) metallic bilayer, that changes its chemical etching properties when heated by exposure to laser radiation. The exposed area is resistant to hydrochloric acid mixtures (HCl:H₂O₂:H₂O, 1:1:48) and nitric acid mixtures, while the unexposed area is removed in the same acid mixture. The timing of the laser pulses is controlled to form a pattern of exposed regions in the resist layer, with this pattern ultimately resulting in the desired pattern of data islands and nondata islands in the recording disks when they are nanoimprinted by the master disk. After the resist layer has been exposed to form the pattern, the resist layer and master disk substrate can be etched, such as by special chemicals or by reactive-ion-etching (RIE), with the exposed regions that are now resistant to the etching acting as a mask. The etching is performed into the master disk substrate so that after removal of remaining resist, the master disk substrate has the desired pattern and can be used as the nanoimprinting stamper.

For a fuller understanding of the nature and advantages of the present invention, reference should be made to the following detailed description taken together with the accompanying figures.

### BRIEF DESCRIPTION OF THE DRAWING

FIG. 1 is a schematic of the system for patterning a master disk to be used for nanoimprinting patterned magnetic recording disks.

FIG. 2 is a enlarged sectional view of a portion of the master disk and the aperture structure on an air-bearing carrier.

FIG. 3 is a view of the output side of the aperture structure as seen from the master disk and shows a metal film with a periodic surface corrugation surrounding the aperture.

FIG. 4A illustrates a C-shaped aperture.

FIG. 4B illustrates an H-shaped aperture.

FIG. 4C illustrates a bowtie-shaped aperture.

FIG. 5A illustrates a C-shaped aperture with a characteristic dimension d.

FIG. 5B illustrates a square aperture with the same area as the C-shaped aperture of FIG. 5A.

FIG. 5C illustrates a rectangular aperture with the same area as the C-shaped aperture of FIG. 5A.

FIG. 5D illustrates a square aperture with dimensions calculated to provide the same near-field spot size as the C-shaped aperture of FIG. 5A.

FIG. 6 illustrates an aperture structure located within an opening in the body of the carrier and in which the aperture structure is a solid immersion lens (SIL).

FIG. 7 illustrates an aperture structure incorporated within a carrier formed of radiation-transmissive material and in which the aperture structure is a super-hemispherical SIL.

### DETAILED DESCRIPTION OF THE INVENTION

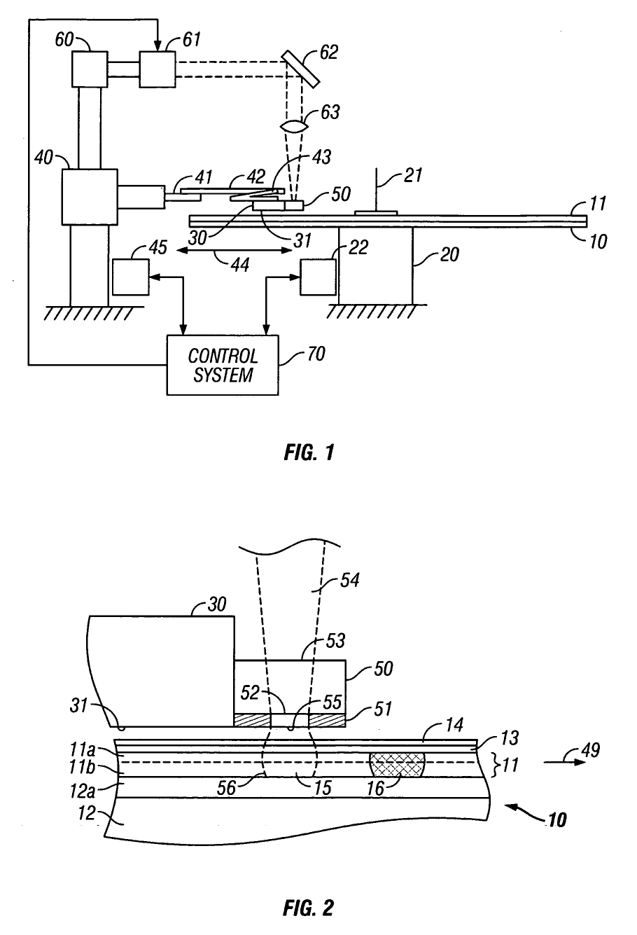

FIG. 1 is a schematic of the system for patterning a master disk that is to be used for nanoimprinting patterned magnetic recording disks. The master disk 10 with photoresist layer 11 is supported on a spindle motor 20 that rotates about axis 21. The spindle motor 20 may be a commercially available air-bearing spindle motor with very low non-repeatable runout, e.g., less than about 1 nm at 1000 RPM, that has a fine-line rotational encoder 22 that provides precise angular positioning information. A carrier 30 has an air-bearing surface (ABS) 31 that faces the master disk and supports the carrier 30 in very close proximity, e.g., about 10 to 20 nm above the master disk 20. The carrier 30 supports the aperture structure 50 that outputs radiation to the resist layer 11. The carrier 30 is connected to a carrier support 40 that includes a rigid arm 41 and a suspension that includes load beam 42 and flexure 43. The suspension is a conventional suspension like that used in magnetic recording disk drives, wherein the flexure 43 allows the carrier 30 to “pitch” and “roll” while it is supported above the rotating master disk 10 by the ABS 31.

The carrier 30 and the master disk 10 are movable relative to one another in a radial direction perpendicular to axis 21, as shown by arrow 44. In FIG. 1, this is accomplished by having the spindle motor 20 fixed and the carrier support 40 being the radial positioner or actuator, either a linear actuator that moves the carrier 30 along a purely radial line or a rotary actuator, such as a rotary voice-coil-motor (VCM) actuator, that rotates the carrier 30 along a generally radial or arcuate path. The actuator has closed-loop absolute position control (using high-resolution radial position encoder 45) to position the carrier 30 at the desired radius on the master disk 10. Alternatively, the carrier support 40 may be fixed and the rotational positioner may be a translational stage on which the spindle motor 20 is mounted and that moves the master disk 10 in the radial direction relative to the fixed carrier 30. The translational stage would also include a high-resolution encoder to provide precise radial positioning information.

The patterning system includes an optical system that directs laser radiation to the aperture structure 50. In FIG. 1 the optical system includes laser 60, modulator 61, mirror 62 and focusing lens 63. If the carrier support 40 is fixed, the optical system may also be fixed. If the carrier support 40 is a movable actuator then in one embodiment the focusing lens and mirror may be attached to the actuator so that the laser radiation is always directed to the aperture structure 50 as the carrier 30 moves generally radially. An example of this type of system is shown and described in U.S. Pat. No. 5,497,359. Alternatively, the radiation from laser 60 may be delivered to the aperture structure 50 by an optical fiber. The radiation wavelength of laser 60 may be selected from a range of wavelengths. Most commonly used lasers are diode-pumped solid state lasers, e.g., Nd:YAG or Nd:YLF. These may be frequency multiplexed to give radiation at higher harmonics. For example a Nd:YAG laser with frequency multiplexing may be used to generate radiation at 1064 nm, 532 nm, 355 nm or 266 nm. Additionally, the radiation from the laser may be modulated using external modulators. Pockel cell modulators with frequencies up to 50 MHz are commercially available. Mode-locked lasers also provide rapid pulses with frequencies up to about 100 MHz. Other lasers such as pulsed diode lasers may also be used. The focusing lens 63 may also be located on or incorporated into the carrier 30.

A shown in FIG. 1, a controller or control system 70 receives angular position information from rotational encoder 22 and radial position information from encoder 45 (or from the translational stage encoder if the spindle motor 20 is movable). The control system is programmed with the desired pattern to be applied to the master disk 10, which corresponds to the pattern that will be nanoimprinted in the magnetic recording disks to form both the data islands in the concentric data tracks and nondata marks, such as servo sectors and synchronization marks, that may extend across multiple tracks. The control system 70 controls the radial positioner (the movable actuator carrier support 40 in FIG. 1, or the translational stage if the spindle motor 20 is movable) and the laser modulator 61 to time the laser pulses to form the desired pattern in the resist layer 11 of master disk 10. In another embodiment the laser may be able to deliver pulses on demand, in response to a trigger signal.

FIG. 2 is a enlarged sectional view of a portion of the master disk 10 and the aperture structure 50 on carrier 30 as they appear in operating relationship. The disk is rotating in the direction 49 which causes the carrier 30 to be maintained in very close proximity, e.g., between about 1 to 50 nm, from the master disk 10 due to the ABS 31 on carrier 30.

The body of aperture structure 50 is formed of a material, such as glass, quartz or another dielectric material, that is transmissive to radiation at the wavelength of the laser. A film 51 of material substantially reflective to the radiation at the wavelength of the laser is formed on the disk-facing side and has an aperture 52 formed in it. The aperture structure 50 has an input side 53 that receives the incident laser radiation 54 and an output side 55 at the exit of aperture 52. The film 51 is preferably a metal such as gold, silver, chromium or another suitable alloy or multilayer structure. The aperture 52 may be formed by etching the film 51 by a focused ion beam (FIB) or by e-beam lithography. The area of the film 51 that is removed to form the aperture 52 may be backfilled by a dielectric material transmissive to radiation at the wavelength of the laser to ensure planarity of the surface facing the disk 10. Alternatively, the side 55 of the aperture 52 facing the disk 10 can be made planar with the outer surface of film 51 by first etching the body of aperture structure 50, e.g., with FIB or e-beam lithography, to a depth corresponding to the thickness of the film 51 that is deposited later. The film 51 is then deposited to the desired thickness, resulting in the surface 55 of aperture 52 being substantially planar with the outer surface of film 51, substantially as shown in FIG. 2.

The aperture 52 is subwavelength-sized, i.e., its diameter if it is circularly-shaped or its smallest feature if it is non-circular, is less than the wavelength of the incident laser radiation and preferably less than one-half the wavelength of the laser radiation. The resist layer 11 is maintained in the near-field of the aperture output, i.e., within a distance less than the radiation wavelength, as depicted by dashed lines 56.

The master disk 10 includes a substrate 12 that may be any suitable material, such as a wafer of single-crystal silicon, with or without an optional film 12a, such as a film of SiO₂ or SiN. The resist layer 11 is preferably a photoresist that is generally insensitive to light with a wavelength greater than about 400 nm so that it can be handled in room light. The photoresist is a material that changes its optical or chemical etching properties when heated by exposure to laser radiation. In the preferred embodiment the resist layer 11 is a metallic bilayer thermal resist, such as a layer 11a of bismuth (Bi) on a layer 11b of indium (In). When this resist is exposed the temperature of the Bi/In film is raised sufficiently that it is converted into a new material with quite different characteristics from the unexposed, so that the unexposed areas can be removed during development with an etchant. This resist is described in detail by G. Chapman et al., “Wavelength Invariant Bi/In thermal Resist As A Si Anisotropic Etch Masking Layer and Direct Write Photomask Material”, Advances in Resist Technology and Processing XX, Theodore H. Fedynyshyn, Editor, Proceedings of SPIE, Vol. 5309 (2003) pp. 472-483. A thin overcoat 13, such as a sputter-deposited “diamond-like” essentially amorphous carbon film, like that used as a protective overcoat on conventional magnetic recording disks, may optionally be formed on the resist layer 11. A layer 14 of liquid lubricant, such as a perfluoropolyether (PFPE) like that used on conventional magnetic recording disks, may optionally be used on the resist layer 11, either directly on resist layer 11 or on the overcoat 13. The optional overcoat 13 and lubricant layer 14 may improve the flyability of the carrier 30 above master disk 10.

As shown in FIG. 2, when a laser pulse is input to aperture 52, the radiation output from aperture 52 exposes a region 15 of resist layer 11 within the near-field 56. After exposure the region 15 will have been sufficiently heated to form a new material different from the unexposed regions of layer 11. The master disk 10 is rotating in the direction 49 while the laser is pulsing. Thus region 16 represents a region that was previously exposed by a laser pulse when region 16 was directly below the aperture output side 55. In FIG. 2, the size of the regions 15, 16 are depicted as corresponding to the size created from a single laser pulse. However, the width of the exposed regions in the direction 49 can be varied by varying the on-time of the laser. This permits the master disk 10 to be formed with the patterns required to nanoimprint the magnetic recording disks with nondata marks, such as servo sectors and synchronization marks, in addition to the data islands. After the resist layer has been exposed, the resist layer and master disk substrate can be etched, such as by chemical etchants or reactive-ion-etching (RIE), with the exposed regions that are now resistant to the etching acting as a mask. The exposed regions are resistant to hydrochloric acid mixtures (HCl:H₂O₂:H₂O, 1:1:48) and nitric acid mixtures, while the unexposed regions are removed in the same acid mixture. The etching is performed into the master disk substrate so that after removal of remaining resist, the master disk substrate has the desired pattern and can be used as the nanoimprinting stamper.

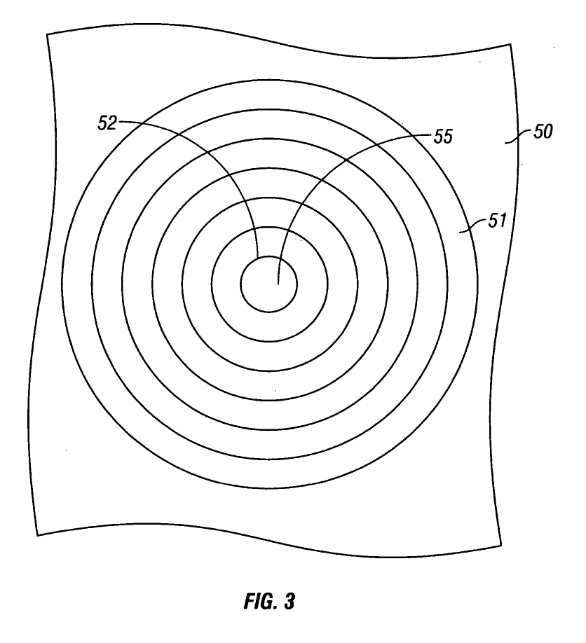

FIG. 3 is a view of the output side 55 of aperture structure 50 as seen from the master disk and shows a modification to the aperture structure wherein the metal film 51 surrounding the aperture 52 has a periodic corrugation or ridge surface structure, as depicted by the concentric circular pattern. It is known that optical transmission through a subwavelength aperture in a metal film is enhanced when the incident radiation is resonant with surface plasmons at a corrugated metal surface surrounding the aperture. Thus features such as ridges or trenches in the metal film serve as a resonant structure to further increase the emitted radiation output from the aperture beyond what it would be in the absence of these features. The effect is a frequency-specific resonant enhancement of the radiation emitted from the aperture, which is then directed onto the resist layer, with the resist layer being positioned within the near-field. This resonant enhancement is described by Thio et al., “Enhanced light transmission through a single subwavelength aperture”, Optics Letters, Vol. 26, Issue 24, pp. 1972-1974 (2001); and in US 2003/0123335 A1.

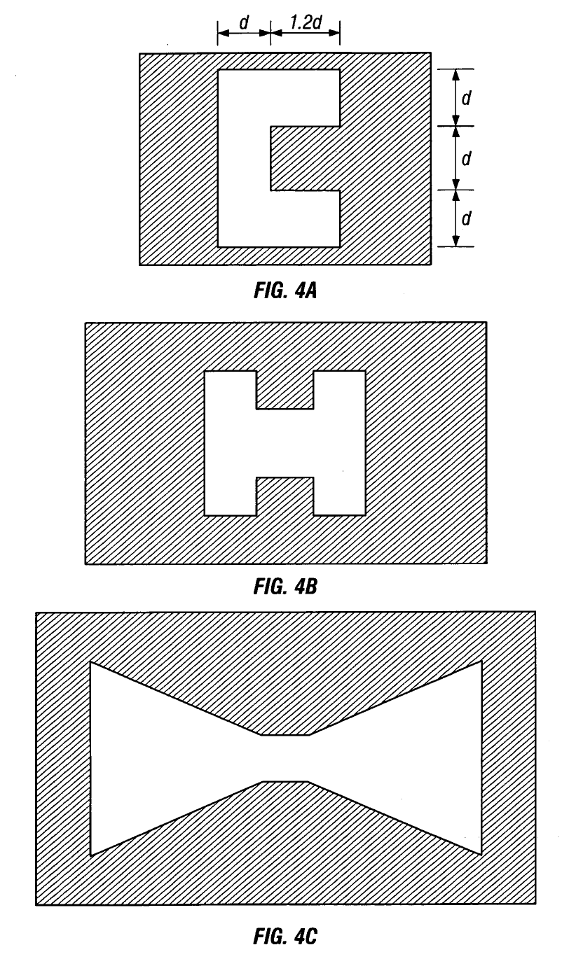

FIGS. 4A-4C illustrate other shapes for the aperture, in particular, a C-shaped aperture (FIG. 4A), an H-shaped aperture (FIG. 4B) and a bowtie-shaped aperture (FIG. 4C). The surface plasmon resonant excitation around these types of apertures enhances the radiation transmission.

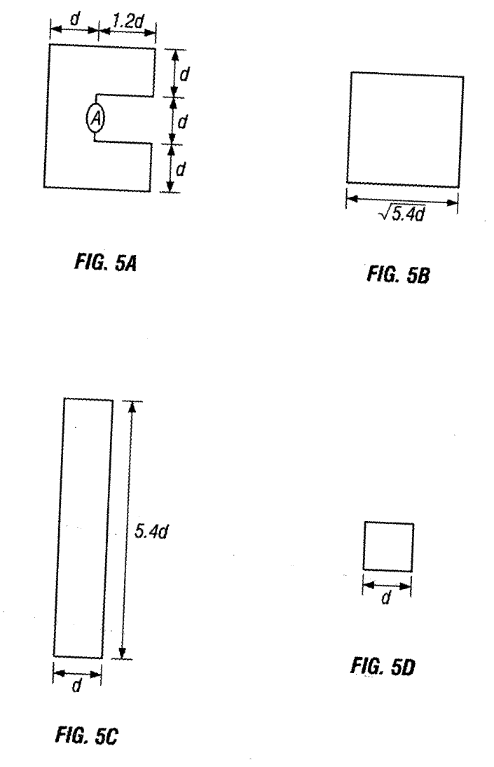

The resonant wavelength depends on the characteristic dimensions of the aperture as well as the electrical properties and thickness of the thin film surrounding the aperture. This is discussed by J. A. Matteo et. al., Applied Physics Letters, Volume 85(4), pp 648-650 (2004) for a C-shaped as shown in FIG. 5A. The aperture was made using a 160 micron thick fused silica as a substrate. A 5 nm thick Cr film was deposited on the substrate, followed by a 200 nm thick Au film. Maximum light transmission was obtained for incident radiation polarized along the X-axis. For the dimension d in the range 40 to 55 nm, the wavelength of the resonantly transmitted light was found to increase from 560 nm to 620 nm. Also shown are a square aperture (FIG. 5B), and a rectangular aperture (FIG. 5C) each with the same area as the C-aperture. FIG. 5D shows a square aperture, calculated to provide the same spot size at near field as the C-aperture. It was found that the rectangular aperture provided the maximum light transmission, while the C-aperture at its resonance provided the best combination of transmission and small spot size.

The near-field spot size is also determined by the characteristic length d. Shi et. al., Optics Letters, 28(15), 1320 (2003), found that for a metal screen that is perfectly conducting, a C-aperture with d of approximately 100 nm will produce a spot size (full-width at half the maximum amplitude, or FWHM) of 136 nm×128 nm. This spot is centered around the area “A” in FIG. 5A. The spot can be somewhat sharpened by lengthening the horizontal arms of the C-aperture.

E. Jin et al., “Obtaining super resolution light spot using surface plasmon assisted sharp ridge nanoaperture”, Applied Physics Letters, Volume 86, 111106 (2005) have calculated that while surface plasmon enhanced transmission can be obtained for the C and the H-apertures, collimation of the transmitted light is lost for these apertures. They report that a bowtie aperture (FIG. 4C) made in a silver film with sharp ridges prevents the loss of collimation. They describe such a bowtie structure as producing a FWHM spot size as small as 12 nm×16 nm.

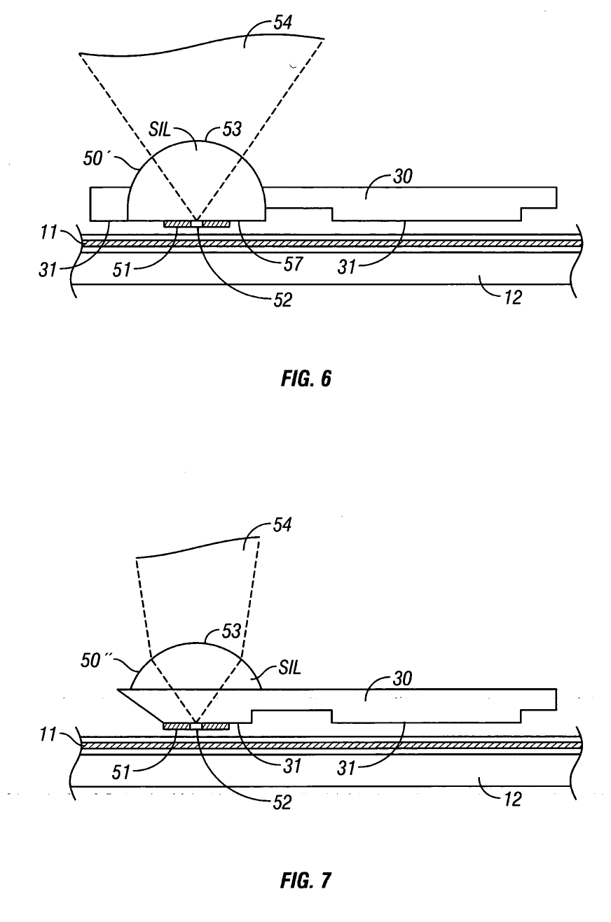

In FIG. 2, the aperture structure 50 is attached to the end of carrier 30. However, the aperture structure may also be a radiation-transmissive portion of carrier 30. The aperture structure may also be located within an opening in the body of the carrier, as shown in FIG. 6 which also depicts an embodiment in which the aperture structure 50′ is a solid immersion lens (SIL). The radiation-reflective film 51 surrounding the aperture 52 is deposited on the planar surface 57 of the hemispherical-shaped SIL, with the planar surface 57 also forming part of the carrier's ABS 31. The aperture structure may also be located on or incorporated within a carrier formed of radiation-transmissive material, as shown in FIG. 7. FIG. 7 also shows an embodiment in which the aperture structure 50″ is a super-hemispherical SIL formed of a hemispherical lens and a portion of the body of carrier 30. Air-bearing sliders with hemispherical and super-hemispherical SILs for optical data recording are described in U.S. Pat. Nos. 5,497,359 and 6,055,220. Numerous other techniques and structures for attachment of the aperture structure to an air-bearing slider or carrier are possible.

Table 1 lists parameters for a system for patterning a master disk for use in nanoimprinting patterned magnetic recording disks with an areal bit density of about 300 Gb/in² For a 2.5 inch disk with this approximate areal density, the linear bit density along the circular data tracks would be in the range of about 0.5 to 1 million bits/inch (BPI) and the track density in the radial direction would be in the range of about 300,000 to 600,000 tracks/inch (TPI).

TABLE 1

| Parameter | Size | Units | Comments |
|---|---|---|---|
| Spot size at aperture | 6.25E−12 | cm² | This produces a spot |
| exit | | | size on the master disk |
| | | | of about 25 nm diameter |
| Input side aperture | 25.00E−08 | cm² | Assume 5 microns × |
| size | | | 5 microns |
| Radiation dose needed | 1.00E−02 | J/cm² | Based on 10 mJ/cm² |
| for resist | | | |
| Aperture transmis- | 1 | | This is a conservative |
| sion efficiency | | | estimate because trans- |
| | | | mission efficiencies as |
| | | | high as 2-4 are |
| | | | predicted. |
| Pulse energy | 2.50E−9 | J | |
| required | | | |
| to be delivered to | | | |
| the aperture | | | |
| Losses in optics | 10 | | This is an estimate of |
| and modulator | | | the losses in the com- |
| | | | ponents between the |
| | | | laser and the aperture. |
| | | | A high loss factor is |
| | | | chosen to show that the |
| | | | available laser can meet |
| | | | the requirements even |
| | | | with this large loss factor. |
| Pulse energy needed | 2.50E−8 | J | |
| from the laser | | | |
| Laser modulator | 0.5 | | |
| duty cycle | | | |
| Number of pulses/ | 5.00E+07 | | |
| second | | | |
| Laser power needed | 0.3125 | W | |
| (CW) | | | |
| Disk speed | 2.5 | m/sec | |
| Pulse length/ | 1.00E−09 | sec-1 | |
| Exposure time | | | |
| Resist layer | 20-50 | nm | |
| thickness | | | |
| Flying height of | 2-50 | nm | |
| carrier | | | |

In addition to pulse length, thermal conductivity of the resist and substrate are factors in resolution. The thermal diffusion tends to increase the size of the heat-affected region. This spread can be reduced by decreasing the pulse length of the laser pulse and the thickness of the resist. The pulse energy is then adjusted to take into account the change in the volume of the treated resist. For this purpose a laser such as a q-switched laser or a mode-locked laser that provides short laser pulses may be used. The q-switched lasers can be diode-pumped solid-state (DPSS) lasers, such as Nd:YLF and Nd:YAG lasers with frequency multiplication. The mode-locked lasers are typically Ti-sapphire lasers. The laser pulse length may be in the range from about 10 picoseconds (10⁻¹² sec) to about 10 nanoseconds (10⁻⁹ sec). While the specific laser wavelengths of interest are 1064 nm, 532 nm, 355 nm, 266 nm and 193 nm, in principle any wavelength may be used, for example a 680 nm wavelength from a diode laser.

While the present invention has been particularly shown and described with reference to the preferred embodiments, it will be understood by those skilled in the art that various changes in form and detail may be made without departing from the spirit and scope of the invention. Accordingly, the disclosed invention is to be considered merely as illustrative and limited in scope only as specified in the appended claims.

What is claimed is:

1. A system for patterning a master disk for nanoimprinting magnetic recording disks, the system comprising:
a master disk comprising a substrate having a substantially planar surface and a resist layer on said substrate surface;
a motor for rotating the master disk about an axis substantially perpendicular to the substrate surface;
a laser;
an aperture structure comprising material substantially reflective to the laser radiation and having an aperture therein, said aperture size being less than the wavelength of the radiation and having an input side for receipt of the radiation and an output side;
a carrier for the aperture structure and having an air-bearing surface (ABS) facing the master disk, the carrier being movable generally radially relative to the spindle motor rotation axis;
a carrier support comprising a rigid arm and a suspension connecting the carrier to the rigid arm, the carrier being maintained with the aperture output side less than the laser radiation wavelength from the resist layer during rotation of the master disk; and
a controller coupled to the laser for timing laser pulses to the input side of the aperture, the controller being responsive to the radial position of the aperture and the angular position of the master disk.

2. The system of claim 1 wherein the carrier support is fixed and the spindle motor is movable.

3. The system of claim 1 wherein the spindle motor is fixed and the carrier support comprises an actuator for moving the rigid arm and attached suspension and carrier.

4. The system of claim 1 wherein the master disk further comprises a liquid lubricant on the resist layer.

5. The system of claim 1 wherein the master disk further comprises a protective film consisting essentially of carbon on the resist layer.

6. The system of claim 1 wherein the resist layer on the master disk comprises a bilayer of bismuth on indium.

7. The system of claim 1 wherein the aperture structure is transmissive to the laser radiation and has a substantially planar surface facing the master disk, and wherein the reflective material comprises a film formed on said aperture structure planar surface.

8. The system of claim 7 wherein the carrier is transmissive to the laser radiation and the aperture structure comprises a portion of the carrier, said reflective film being formed on the ABS of the carrier.

9. The system of claim 7 wherein said reflective film is a metallic film having periodic corrugations.

10. The system of claim 1 wherein the aperture has a shape selected from the group consisting of a C-shape, an E-shape, an H-shape and a bowtie shape.

11. The system of claim 1 wherein the aperture structure comprises a solid immersion lens (SIL).

12. The system of claim 1, where in the laser is a pulsed laser having a pulse length in the range of about 10 picoseconds to about 10 nanoseconds.

13. A method for patterning a master disk for nanoimprinting magnetic recording disks, the method comprising:
providing a master disk to be patterned comprising a substantially rigid substrate having a layer of thermal resist;
providing an aperture structure comprising material substantially reflective to laser radiation at a specified wavelength and having an aperture therein, said aperture having a size less than said specified wavelength;
rotating the master disk about an axis substantially perpendicular to the substrate;
supporting the aperture structure on an air-bearing slider having an air-bearing surface (ABS) facing the rotating master disk, the aperture being maintained less than said specified wavelength from the resist layer during rotation of the master disk; and
directing pulses of laser radiation at said specified wavelength to the aperture to heat regions of the resist.

14. The method of claim 13 wherein providing an aperture structure comprising material having an aperture therein comprises providing a metallic film having periodic corrugations surrounding the aperture.

15. The method of claim 13 wherein providing an aperture structure comprising material having an aperture therein comprises providing a metallic film having an aperture with a shape selected from the group consisting of a C-shape, an E-shape, an H-shape and a bowtie shape.

16. The method of claim 13 system of claim 1 wherein providing a master disk having a layer of thermal resist comprises providing a master disk having a bilayer of bismuth on indium.

17. The method of claim 13 wherein directing laser pulses comprises directing laser pulses at a rate to generate between about 0.5 million to 1 million heated regions of thermal resist per inch.

18. The system of claim 13 wherein directing laser pulses comprises generating laser pulses having a pulse length in the range of about 10 picoseconds to about 10 nanoseconds.
